(19) United States
(12) Patent Application Publication
(10) Pub. No.: US 2016/0232231 A1
(43) Pub. Date: Aug. 11, 2016

(54) SYSTEM AND METHOD FOR DOCUMENT AND/OR MESSAGE DOCUMENT AND/OR MESSAGE CONTENT SUGGESTION, USER RATING AND USER REWARD

(71) Applicant: HUNG VIET DANG, HOCHIMINH (VN)

(72) Inventor: HUNG DANG VIET, HOCHIMINH (VN)

(21) Appl. No.: 14/619,070

(22) Filed: Feb. 11, 2015

(51) Int. Cl. G06F 17/30; H04L 12/58; G06F 3/0482; H04L 29/08; G06F 17/24; G06F 3/0484

(52) U.S. Cl. CPC G06F 17/30643; G06F 17/30598; G06F 17/24; G06F 17/30011; G06F 3/04842; G06F 17/30696; G06F 3/0482; G06F 17/30867; H04L 67/02; H04L 51/046; G06F 17/3089

(57) ABSTRACT

Method and system for enabling document and/or message users suggest each other contents for new document and/or message such as emails, instant messages, blogging and microblogging, social network page updates and other type of user generated contents, based on user's current selection, comprising a database and a content management software application. The suggested contents can be text, voice, video clip or other content objects which are extracted from a user's document and/or message content, are saved into the database, and are imported by other users to their document and/or message content through their owned criteria. The chain of suggestion and selection is continuous one by another until the users finish their document and/or message. Furthermore, rating the system comprises also software applications rating users' activities, enabling users to rate the suggested contents and top rating users can be rewarded.

### BACKGROUND

The present invention relates to systems and methods for automated document and/or message content suggestion.

Today, there is a widespread adoption of word processing applications and the documents such as emails, instant messages, blogging and microblogging, social network page updates and other type of user generated contents. People compose billion document and/or messages per day. Typically, users compose emails, instant messages, blogging and microblogging, social network page updates and other type of user generated contents by themselves without any assistance or suggestion about document and/or message content. Consequently, many document and/or messages are written with poor writing skill and have low quality content that are inappropriate. Moreover, composing document and/or messages become tedious and complicated for the user with modest writing skill. Further, when an document and/or message user needs any content suggestion, he/she has to spend much time to find suitable sources.

International Application Number PCT/IB2013 discloses a method and system for enabling contextual recommendations and collaboration recommendations, based on a user's current work with
a plurality of content collector software applications coupled to a plurality of data networks and adapted to interface with a plurality of content management applications;
an indexing engine software application coupled to a data network;
an expanded social network graph database coupled to a data network;
and a predictive content intelligence software application coupled to a data network;
wherein the plurality of content collector software applications receive as, document fragments, or other content objects from the plurality of content management applications, the indexing engine software application indexes the retrieved documents, document fragments, or content objects, and the expanded social network graph database is modified based at least in part on results of the indexing; and wherein the predictive content intelligence software application, using at least the results of the indexing and the expanded social network graph database, identifies at least a plurality of other content objects and a plurality of people that are relevant to the received documents, document fragments, or content object;

This system and method could recommend user about content of an email, blog, message with plurality of software applications and extract contents from plurality of data networks. However, the method and system are complex, require dedicated hardware and Internet capacity to run, and multiple data resources. Recommendation provided by this method and system depends much on the predictive content intelligence software application, may be more artificial, less user friendly. Further, the recommendation provided by this method and system is raw content that the user has to process more before put it into his/her document and/or messages. A document and/or message user with a limited time for document and/or message composing may prefer a complete sentence suggestion.

In light of the foregoing discussion, there is a need for a simple, user friendly and efficient method and system for suggesting document and/or message content to users.

### SUMMARY

Method and system for enabling document and/or message users suggest each other contents for new document and/or message such as emails, instant messages, blogging and microblogging, social network page updates and other type of user generated contents, based on user's current selection, comprising a database and a content management software application. The suggested contents can be text, voice, video clip or other content objects which are extracted from a user's document and/or message content, are saved into the database, and are imported by other users to their document and/or message content through their owned criteria. The chain of suggestion and selection is continuous one by another until the users finish their document and/or messages. Furthermore, rating the system comprises also software applications rating users' activities, enabling users to rate the suggested contents and top rating users can be rewarded.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow diagram illustrating a system of enabling document and/or message users to suggest each other document and/or message content, in accordance with one embodiment;

FIG. 2 is a flow diagram illustrating a method of enabling document and/or message users to suggest each other document and/or message content, in accordance with one embodiment;

FIG. 3 is an exemplary representation of detecting new content input by user and offer to share it from the system, in accordance with one embodiment;

FIG. 4 is an exemplary representation of displaying criteria for user to select for content suggestion, in accordance with one embodiment;

FIG. 5 is an exemplary representation of a content input by user and offer a suggestion from the system, in accordance with another embodiment;

FIG. 6 is an exemplary representation of a new content suggestion from the system, in accordance with another embodiment;

FIG. 7 is an exemplary representation of a rating request for a new suggested content from the system, in accordance with another embodiment; and

FIG. 8 shows an exemplary system to provide automatic document and/or message content suggestions.

### DESCRIPTION

As briefly described above, embodiments of the present invention are directed to automatically suggesting content for inclusion into document and/or messages. However, such systems can suggest content for other requirements, for example, documents, contacts information, tasks, calendar items, and the like. Given initial text for a given document and/or message, project or collaborative workspace, and identification of local or external content repositories, content associated with the document and/or message may be retrieved and recommended to one or more users for inclusion into the document and/or message.

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

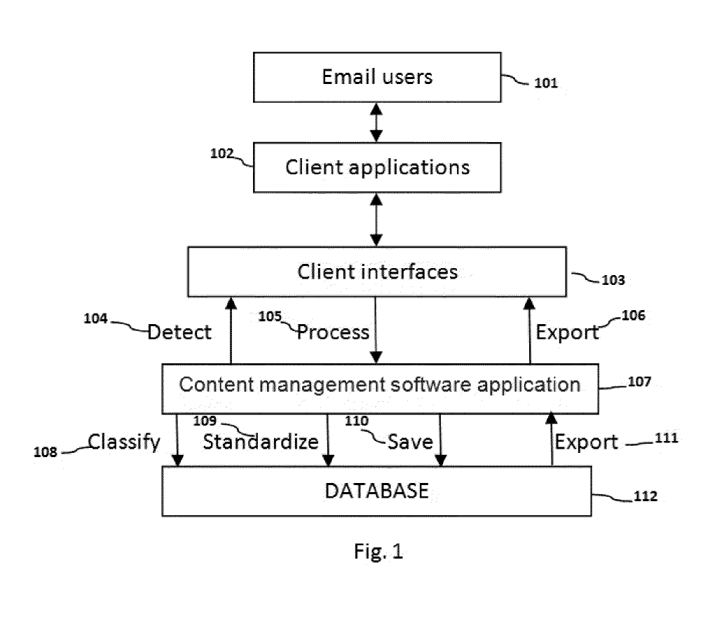

FIG. 1 is a flow diagram illustrating a system of enabling document and/or message users to suggest each other document and/or message content, in accordance with one embodiment. One or more document and/or message users 101 use client applications 102 to communicate document and/or message messages. The client applications 102 interacts through client interfaces 103 with a content management software application 107. The interactions include content detection 104, content processing 105, and exporting 106. The content management software application 107 communicates with a database 112 with requests such as classify 108, standardize 109, save 110 and export 111.

The database 112 can be built from news sources or from the user's own document and/or messages and documents. The system can scan the user's hard drive as part of an initial training process. Information contained in all these various sources may be extracted by an automatic project content suggestion system, and links to each suggested piece of content, data or other resource may be generated. According to embodiments, the automatic document and/or message content suggestion system may be a software application comprised of one or more software application modules operative to extract and search links associated with received document and/or message seed information and to present and process approved links followed by storage of links of prior document and/or messages. If such links are approved by a user creating or maintaining the document and/or messages, then such linked information may be assembled together and/or associated with a given document and/or message topic.

The computing systems and platforms encompassed by the present disclosure include a mobile or web-based information service, interacting with an document and/or message content suggestion engine that is used to help the user with document and/or message content generation. The information service can provide intelligent decision making and reinforcement of certain content to facilitate suggestions for high quality document and/or message contents. In particular, the information service focuses on encouraging a human user to complete a series of discrete, separate actions or activities (to achieve small goals) that in combination will help achieve a larger overall goal of generating a document and/or message text.

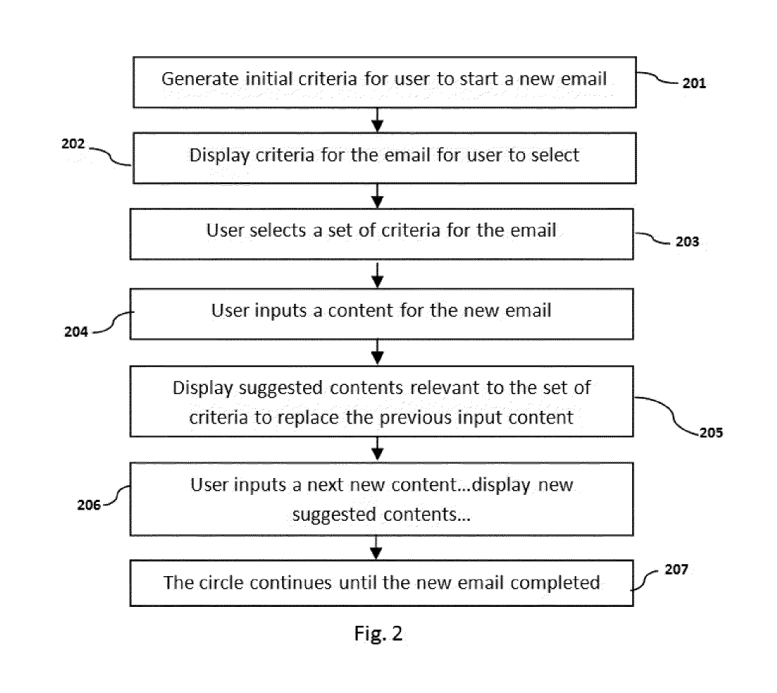

FIG. 2 is a flow diagram illustrating a method of enabling document and/or message users to suggest each other document and/or message content, in accordance with one embodiment. The process generates initial criteria for the user to start a new document and/or message (201). The process then displays one or more criteria for the document and/or message for the user to select (202). The user in turn selects a set of criteria for the document and/or message (203) and then inputs content for the new document and/or message (204). The system displays suggested contents relevant to the set of criteria to replace the previous input content (205). In turn, the user enters another new content, and the system displays newly suggested contents to the user (206), and the process continues until the new document and/or message is completed (207).

In conjunction with operations of the suggestion engine, the information service can adapt to learn a user's behavior patterns and offer personalized, relevant, or timely to help the human user draft high quality document and/or messages. The information service can include various applications and corresponding user interfaces to be viewed by the human user to generate document and/or message content. These interactions, which may be driven by suggested content and suggested content delivery types or timings, are used to help create document and/or message content for the human user. Accordingly, the content suggestion engine acts in a larger environment of an “intelligent” information system that provides appropriate messages and document and/or message content selections to the human user at the right time.

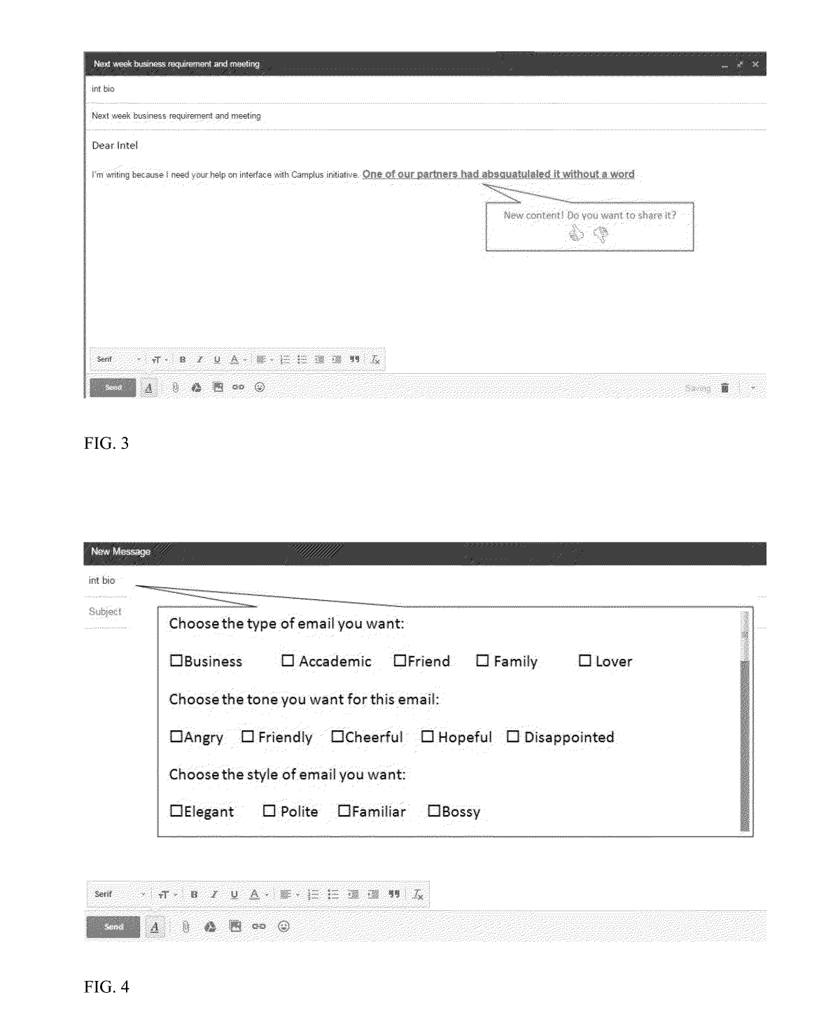

FIG. 3 is an exemplary representation of detecting new content input by user and offer to share it from the system, in accordance with one embodiment. The system automatically generates the content with a linked line and checks if the users wishes to share the content.

FIG. 4 is an exemplary representation of displaying criteria for user to select for content suggestion, in accordance with one embodiment. In this embodiment, the user selects from the type of document and/or message (business, academic, friend, family, or lover, for example). The criteria can also include the tone (angry, friendly, cheerful, and professional, for example). The users can also select the style of document and/or message such as elegant, polite, familiar, or bossy, among others.

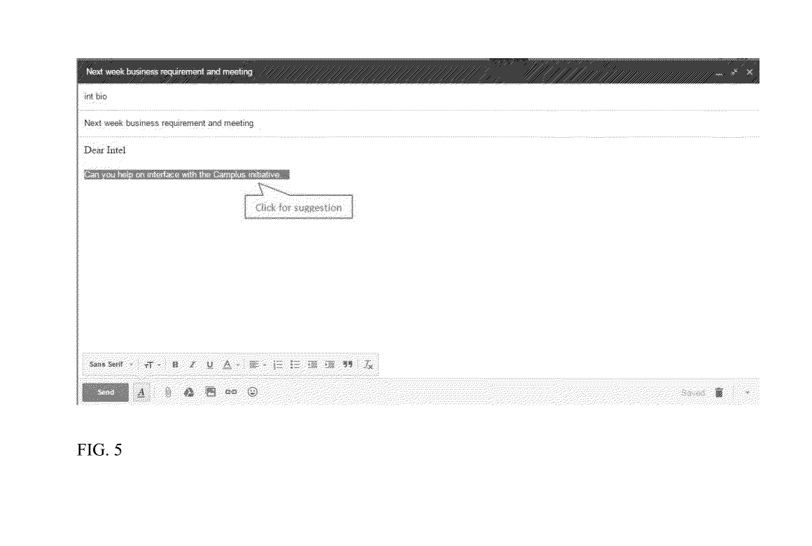

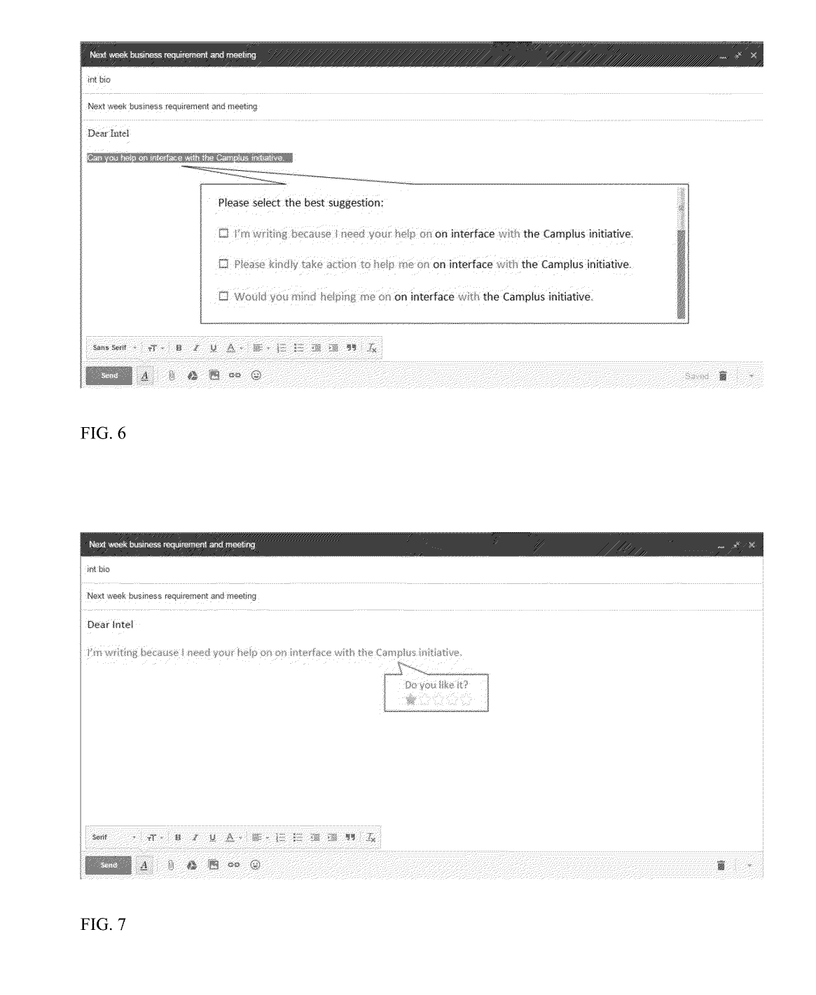

FIG. 5 is an exemplary representation of a content input by user and offer a suggestion from the system, in accordance with another embodiment. The system provides a user prompt with a user interface for requesting a suggestion. Upon requesting help, the system provides 3 options as shown in FIG. 6. FIG. 6 is an exemplary representation of a new content suggestion from the system, in accordance with another embodiment. The user can select one of the suggestions, and FIG. 7 is an exemplary representation of a rating request for a new suggested content from the system, in accordance with another embodiment. The selection text is inserted, and the user can rate the suggestion with a user interface that prompts the user to rate from a one to five star rating in this example.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

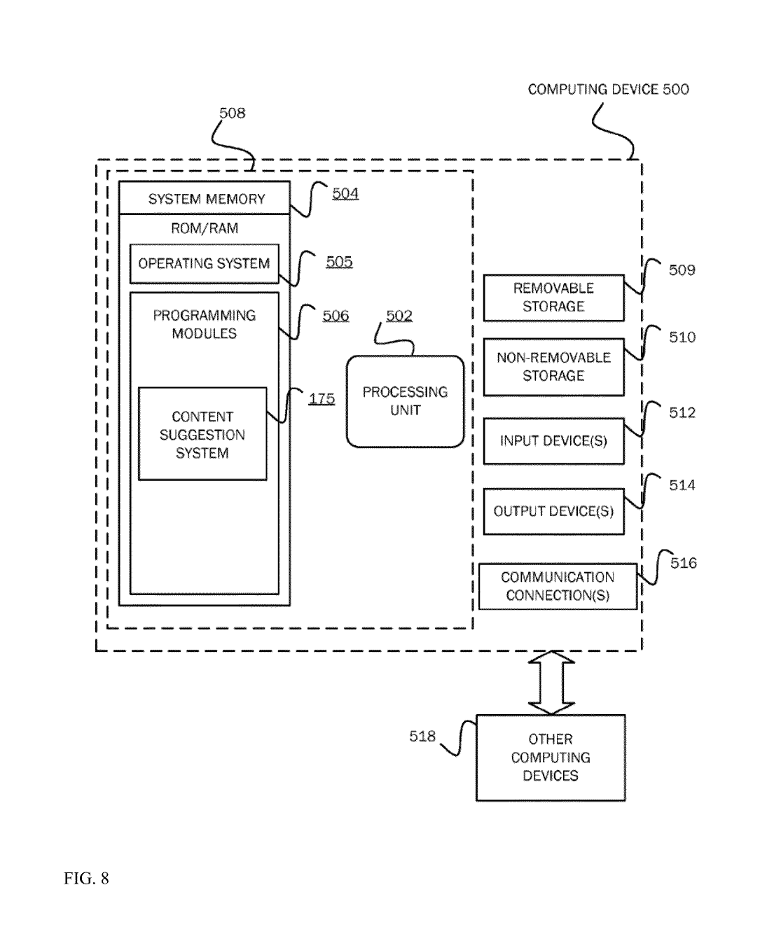

FIG. 8 illustrates a system architecture for providing suggested document and/or message content and resources various client devices after generation as described above. As described previously, an automatic document and/or message content suggestion system 175 can be utilized for suggesting content of various types for inclusion in or association with one or more document and/or messages received via a variety of communication channels and stores. Information and features helpful in suggesting content, resources items for one or document and/or messages may also be stored in different communication channels or other storage types. For example, received and suggested content, resources items and associated metadata or feature information may be stored using directory services, web portals, mailbox services, instant messaging stores and social networking sites 430. The automatic document and/or message suggestion system 175 may use any of these types of systems or the like to store suggested content, resources items and associated metadata in a suggested content store. A server may provide suggested content, resources items and associated metadata to various clients. As one example, server may be a web server providing suggested content, resources items and associated metadata over the web. Server may provide online content suggested content, resources items and associated metadata over the web to clients through a network. Examples of clients that may obtain suggested content, resources and associated metadata include computing device, which may include any general purpose personal computer, a tablet computing device and/or mobile computing device 405 which may include smart phones. Any of these devices may obtain the suggested content, resources and associated metadata from the store.

As described above, embodiments of the invention may be implemented via local and remote computing and data storage systems, including the systems illustrated and described with reference to FIGS. 1-2. Consistent with embodiments of the invention, the aforementioned memory storage and processing unit may be implemented in a computing device, such as computing device 500 of FIG. 8. According to embodiments, the computing device may be in the form of a personal computer, server computer, handheld computer, smart phone, tablet or slate device, or any other device capable of containing and operating the computing components and functionality described herein. In addition, the computing device components described below may operate as a computing system printed on a programmable chip. Any suitable combination of hardware, software, or firmware may be used to implement the memory storage and processing unit. For example, the memory storage and processing unit may be implemented with computing device 500 or any other computing devices 518, in combination with computing device 500, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention.

With reference to FIG. 8, a system consistent with embodiments of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include the conversation topic detection, generation and storage system 200 having sufficient computer-executable instructions, which when executed, performs functionalities as described herein. Operating system 505, for example, may be suitable for controlling computing device 500's operation. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 8 by a removable storage 509 and a non-removable storage 510. Computing device 500 may also contain a communication connection 516 that may allow device 500 to communicate with other computing devices 518, such as over a network in a distributed computing environment, for example, an intranet or the Internet. Communication connection 516 is one example of communication media.

As stated above, a number of program modules and data files may be stored in system memory 504, including operating system 505. While executing on processing unit 502, programming modules 506 and may include the automatic document and/or message content suggestion system 175 which may be program modules containing sufficient computer-executable instructions, which when executed, performs functionalities as described herein. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A system for composing document and/or message such as emails, instant messages, blogging and microblogging, social network page updates and other type of user generated contents, comprising:
a processor;
a database coupled to the processor;
a content management software application coupled to the database;
code to detect new contents from user's document and/or message;
code to classify and save the detected new content into the database;
code to compare a content input by an user when composing document and/or message with saved contents;
code to display saved contents which are similar to the user input content from the database to user's interface in order to suggest the user to choose the best content for their document and/or message; and
code to suggest content for new document and/or message based on a user's current selection.

2. The system of claim 1, wherein the suggested content comprises text, voice, video clip or other content objects which are extracted from users' document and/or messages, are saved into the database, managed by the content management software application and are displayed on users' interface based on similarity between the saved contents and the user's input ones.

3. The system of claim from 1, wherein the content management software application classifies new content detected from a user's document and/or message based on a set of criteria and the content suggested to users based also on the criteria selected by the users.

4. The system of claim 1, wherein the content management software application standardizes the new content.

5. The system of claim 1, comprising a predictive content intelligence software application coupled to the database.

6. The system of claim 1, comprising a rating software application for enabling users to rate the suggesting contents.

7. The system of claim of 1, comprising a rating software application that rates user's activities.

8. The system of claim 7, wherein top rating users are rewarded.

9. A method for generating content of document and/or message such as emails, instant messages, blogging and microblogging, social network page updates and other type of user generated contents, comprising:
detecting new contents from user's document and/or message that has been input to an document and/or message composing system by a content management software application;
classifying and saving the detected new content into the database;
comparing a content input by an user when composing document and/or message with saved contents;
displaying saved contents which are similar to the user input content from the database to user's interface in order to suggest the user to choose the best content for their document and/or message; and
generating document and/or message contents based on document and/or message composer's current selection.

10. The method of claim 9, wherein the new content detected from an user's document and/or message are classified based on a set of criteria by the content management software application and the content are suggested to users also based on the criteria selected by the users.

11. The method of claim 9, wherein the new content are standardized by the content management software application.

12. The method of claim 9, wherein suggested contents are rated by user.

13. The method of claim 9, wherein users' activities rated by a rating software application.

14. The method of claim 9, wherein top rating users are rewarded.

15. A system, comprising:
a server having:
a processor;
a database coupled to the processor;
a content management software application coupled to the database;
code to detect new contents from user's document and/or message;
code to classify and save the detected new content into the database;
code to compare a content input by an user when composing document and/or message with saved contents;
code to display saved contents which are similar to the user input content from the database to user's interface in order to suggest the user to choose the best content for their document and/or message; and
code to suggest content for new document and/or message based on a user's current selection; and
one or more client computers each running a document and/or message composing software in communication with the code to suggest content for new document and/or message.

16. The system of claim 15, wherein the suggested content comprises text, voice, video clip or other content objects which are extracted from users' document and/or messages, are saved into the database, managed by the content management software application and are displayed on users' interface based on similarity between the saved contents and the user's input ones.

17. The system of claim from 15, wherein the content management software application classifies new content detected from a user's document and/or message based on a set of criteria and the content suggested to users based also on the criteria selected by the users.

18. The system of claim 15, wherein the content management software application standardizes new content.

19. The system of claim 15, comprising software applications rating users' activities, enabling users to rate the suggested contents and top rating users can be rewarded.

20. The system of claim 19, wherein top rating users are rewarded.
